(19) United States
(12) Patent Application Publication
(10) Pub. No.: US 2025/0133273 A1
(43) Pub. Date: Apr. 24, 2025

(54) MACHINE LEARNING ASSISTED AND TEMPLATE GUIDED VIDEO SYNTHESIS

(71) Applicant: GOOGLE LLC, Mountain View, CA (US)

(72) Inventors: Francesco Infante, Mountain View, CA (US); Haotian Fang, Mountain View, CA (US); Aiden Liu, Mountain View, CA (US); Melis Atarim, Mountain View, CA (US); Laurynas Tamulevicius, Mountain View, CA (US); Bence Demkó, Mountain View, CA (US); Miquel Farré, Mountain View, CA (US)

(21) Appl. No.: 18/383,282

(22) Filed: Oct. 24, 2023

(51) Int. Cl. H04N 21/81; G06F 40/40

(52) U.S. Cl. CPC H04N 21/816; G06F 40/40

(57) ABSTRACT

A method for generating video content includes obtaining first information that includes information associated with a user or a content sponsor. The method also includes generating text content at least in part by applying the first information to a generative artificial intelligence model, and obtaining image content. The method further includes generating video content, at least by applying the text content and the image content as inputs to a template model. The template model causes the generated video content to conform to one or more temporal characteristics defined by the template model.

### FIELD OF TECHNOLOGY

The present disclosure relates to video synthesis and, more specifically, to combinations of machine learning techniques and template-guided video synthesis techniques.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

In various use cases, it is desirable to generate video content based on static content (i.e., content that does not change over time, such as images and text). As one example, in digital advertising, some advertisers produce only image and text ads but not video ads. To provide video content, which tends to be more appealing and relatable, some existing techniques use software to extrapolate video from the advertiser's images and text. However, these techniques tend to have substantial drawbacks.

Some of the existing techniques use deep neural networks, including large language models (LLMs), to generate video content based on text and image inputs (e.g., text and images provided by an advertiser). The use of deep neural networks enables the video content to be generated more quickly and efficiently, thereby facilitating the creation of customizable video content on an as-needed (“on-the-fly”) basis, and/or enabling the creation of a larger collection of video content. Currently, however, the quality of videos generated in this manner tends to be orders of magnitude below that of videos authored by humans (e.g., professionals in the advertising field). As one example, videos generated by deep neural networks tend to lack temporal consistency across video frames. Moreover, using deep neural networks to generate video can create other uncertainties or risks. For example, due to the potential impact on an advertiser's brand, the advertiser may want more control over the narrative and/or visuals of a video advertisement than such techniques have previously provided.

Other existing techniques instead use a template-based approach. Template models (also referred to herein simply as “templates”) generally define temporal characteristics of video, such as animations and sequences that contain text and images, with the text and images being applied as inputs to template models. While using templates of this sort can ensure a more controlled space with greater temporal consistency across video frames, the resulting videos are greatly constrained by the limited volume, and the generally fixed nature, of the images and text that were applied as inputs to the template models.

### SUMMARY

In one example implementation, a method for generating video content includes: obtaining, by a computing system, first information, the first information including information associated with a user or a content sponsor; generating, by the computing system, text content at least in part by applying the first information to a generative artificial intelligence model; obtaining, by the computing system, image content; and generating, by the computing system, video content, at least in part by applying the text content and the image content as inputs to a template model, wherein the template model causes the generated video content to conform to one or more temporal characteristics defined by the template model.

In another example implementation, a computing system includes one or more processors and one or more non-transitory, tangible memories storing instructions. The instructions, when executed by the one or more processors, cause the computing system to: obtain first information, the first information including information associated with a user or a content sponsor; generate text content at least in part by applying the first information to a generative artificial intelligence model; obtain image content; and generate video content, at least in part by applying the text content and the image content as inputs to a template model, wherein the template model causes the generated video content to conform to one or more temporal characteristics defined by the template model.

### BRIEF DESCRIPTION OF THE DRAWINGS

FIG. 1 is a block diagram of an example system in which techniques for efficiently generating high-quality video content can be implemented.

FIG. 2 depicts an example process for efficiently generating high-quality video content.

FIG. 3 depicts a more specific example of the process of FIG. 2, according to one implementation.

FIG. 4 depicts an example video synthesis scenario according to one implementation of the techniques disclosed herein.

FIG. 5 is a flow diagram of an example method for efficiently generating high-quality video content.

### DETAILED DESCRIPTION OF THE DRAWINGS

Generally, implementations disclosed herein can efficiently generate high-quality video content. To this end, a computing system (e.g., a server or network of servers) can generate text content using certain input information and a generative artificial intelligence model (e.g., a deep neural network such as a large language model (LLM)). The computing system may apply the information directly as input to the deep neural network, and/or may use the information to generate the input to the deep neural network. For example, the computing system may use the information to generate a text prompt, and apply the text prompt as an input to an LLM using an application programming interface (API) associated with the LLM (e.g., an API made available by an entity that maintains the LLM). The LLM then processes/interprets the text prompt and generates a responsive text response as an output.

The information on which generation of the text content is based may include information associated with a sponsor of the video being generated (e.g., text of an advertiser website that is to serve as a landing page for an ad that will include the video) and/or information associated with a user to whom the video is to be presented (e.g., the user's search query, location, etc.). The generated text can include a set of sentences, phrases, or words, or only a single sentence, phrase, or word, for example. The computing system applies the generated text, along with one or more images, as inputs to a template model (e.g., via another API), where the template model defines one or more temporal characteristics (e.g., animations and/or sequences) of video.

In some implementations, the computing system selects the image content to apply to the template model based on one or more factors (e.g., based on the relevance of images as predicted by another machine learning model), generates the image content (e.g., using another machine learning model), or retrieves the image content (e.g., from an advertiser or other entity). Additionally or alternatively, in some implementations, the computing system uses another generative artificial intelligence model to select the template itself (e.g., by predicting which template is most likely to generate a video advertisement that a user would select in a particular context).

Once the computing system generates the video content, the video content can be used for any suitable purpose. For example, the computing system or a third-party server may use the video content as a candidate in a particular content selection process. In digital advertising, for instance, the video content may be an ad that serves as a candidate, in an auction or other content selection process, for displaying to a user in a particular situation.

The techniques disclosed herein can improve the efficiency of video synthesis and the quality of the resulting video. In particular, the techniques can provide advantages of machine learning techniques (e.g., by enabling video content to be generated more quickly and efficiently, thereby facilitating the creation of customizable video content on an as-needed basis, and/or enabling the creation of a larger collection of video content) and advantages of template-guided techniques (e.g., ensuring a more controlled space, leading to greater temporal consistency across video frames), while alleviating drawbacks of machine learning techniques (e.g., lower quality due to a lack of temporal consistency across video frames) and drawbacks of template-guided techniques (e.g., video synthesis that is greatly constrained by the limited volume, and the generally fixed nature, of the image and text inputs that were applied as inputs to the template models).

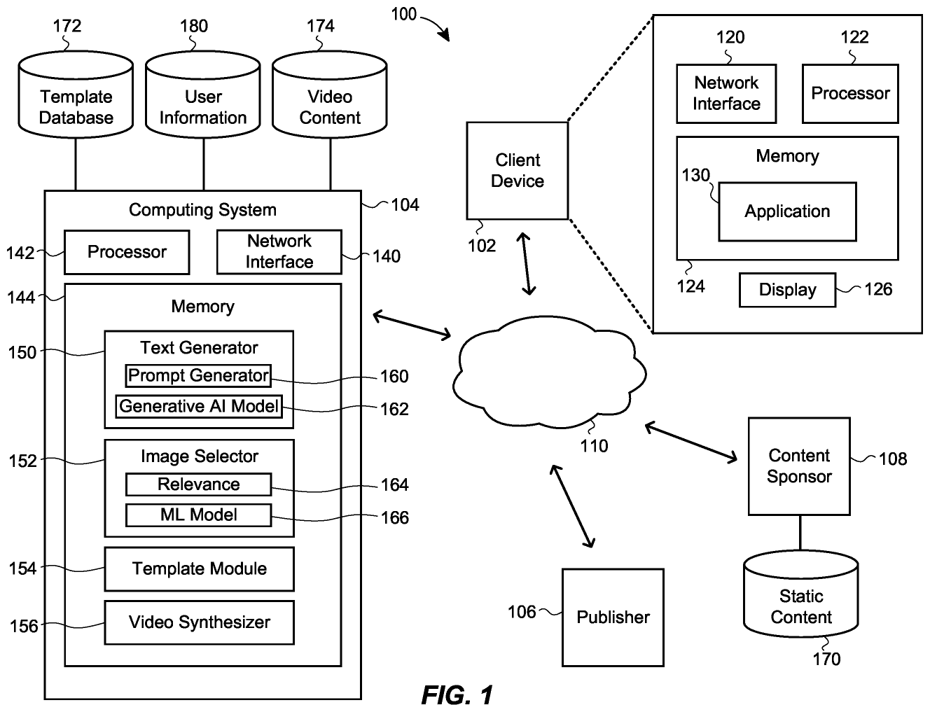

FIG. 1 illustrates an example system 100 in which one or more techniques for efficiently providing high-quality video content may be implemented. As used herein, the term “high-quality” may refer to quality that is subjectively (or objectively/measurably) higher than any desired benchmark, for example. The example system 100 includes a client device 102, a computing system 104, a publisher 106, a content sponsor 108, and a network 110. The computing system 104 is remote from the client device 102, and communicatively coupled to the client device 102 via the network 110. The communicative/network connections shown in FIG. 1 for the publisher 106 and the content sponsor 108 represent communicative/network connections with computing devices or systems that are associated with the publisher 106 and the content sponsor 108, respectively.

The network 110 may be a single communication network (e.g., the Internet), and in some implementations also includes one or more additional networks. As just one specific example, the network 110 may include a cellular network, the Internet, and a server-side local area network (LAN). While FIG. 1 shows only a single client device 102, publisher 106, and content sponsor 108, it is understood that the system 100 may include any suitable number of similar client devices, publishers, and/or content sponsors operating according to the principles disclosed herein.

Generally, the client device 102 can access one or more information resources supplied or published by the publisher 106, and the computing system 104 generates video content that may populate one or more content slots within the information resource(s) when presented to a user at the client device 102. For example, the information resources may be web pages of a website hosted by the publisher 106, and the content sponsor 108 may sponsor one or more video advertisements or other content items that the computing system 104 creates and uses to fill content slots within those web pages. Alternatively, the computing system 104 may create video content for the content sponsor 108, while another computing system (not shown in FIG. 1) determines whether, and when, that video content is to be included in an information resource of publisher 106 and/or other publishers. In still other implementations, the publisher 106 or the content sponsor 108 creates the video content, in which case the computing system 104 is associated with the publisher 106 or the content sponsor 108, respectively.

In some implementations and/or scenarios, the computing system 104 (or another computing system not shown in FIG. 1) causes the generated video content to be included in a different type of information resource presented at the client device 102, other than a web page. For example, the information resource may be a screen/user interface/page of an application (e.g., a mobile app) provided by the publisher 106 or another entity to the client device 102 for installation, where the screen/user interface/page includes content slots that are to be populated (e.g., by computing system 104) with the generated video content. As another example, the information resource may be a video played by a video player of the client device 102, and the content slots may be distributed in time throughout the video.

The client device 102 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, the client device 102 includes a network interface 120, a processor 122, memory 124, and a display 126. The processor 122 may be a single processor (e.g., a central processing unit (CPU)), or may include a set of processors (e.g., multiple CPUs, or one or more CPUs and one or more graphics processing units (GPUs)).

The memory 124 includes one or more computer-readable, non-transitory storage units or devices, which may include persistent (e.g., hard disk) and/or non-persistent memory components. The memory 124 stores instructions that are executable by the processor 122 to perform various operations, including the instructions of various software applications and the data generated and/or used by such applications. In the example implementation of FIG. 1, the memory 124 stores at least an application 130, which may be, for example, a web browser application, a mobile application downloaded from an application store, or a video player application.

Generally, the application 130 is executed by the processor 122 to present information resources to the user of the client device 102 via the display 126 (and possibly one or more speakers of the client device 102, not shown in FIG. 1), with at least one of those information resources including one or more spatial and/or temporal content slots for dynamically presenting video content. In an implementation where the application 130 is a web browser application, for instance, an information resource may be a web page hosted by the publisher 106, with the web browser causing the client device 102 to download HyperText Markup Language (HTML), scripts, and/or other code of the web page for presentation to a user via the display 126. As another example, the application 130 may be a video sharing application such as Google's YouTube®, and the information resource may be a user interface generated by the video sharing application and presented via the display 126. As yet another example, the application 130 may be a video player application, and the information resource may be a video played by the video player application.

The display 126 includes hardware, firmware, and/or software configured to enable a user to view visual outputs of the client device 102, and may use any suitable display technology (e.g., LED, OLED, LCD, etc.). In some implementations, the display 126 is incorporated in a touchscreen having both display and manual input capabilities. Moreover, in some implementations where the client device 102 is a wearable device, the display 126 is a transparent viewing component (e.g., lenses of smart glasses) with integrated electronic components. For example, the display 126 may include micro-LED or OLED electronics embedded in lenses of smart glasses.

The network interface 120 includes hardware, firmware, and/or software configured to enable the client device 102 to exchange electronic data with the computing system 104 via the network 110. For example, the network interface 120 may include a cellular communication transceiver, a WiFi transceiver, and/or transceivers for one or more other wired and/or wireless communication technologies.

While FIG. 1 shows client device 102 as a single component communicating directly (i.e., via network 110) with the computing system 104, in some implementations the subcomponents of client device 102 shown in FIG. 1 are instead divided among two or more user-side devices. As just one example, a pair of smart glasses may include the processor 122, the memory 124, and the display 126, while a smartphone may include another processing unit, another memory, another display, and the network interface 120. The smart glasses (or smart helmet, etc.) may then communicate as needed with the smartphone (e.g., via Bluetooth) to enable the operations described herein.

The computing system 104 includes a network interface 140, a processor 142, and memory 144. The network interface 140 includes hardware, firmware, and/or software configured to enable the computing system 104 to exchange electronic data with the client device 102 and other, similar client devices via the network 110. For example, the network interface 140 may include a wired or wireless router and a modem. The processor 142 may be a single processor, or may include two or more processors. The computing system 104 may include one or more servers, for example, which may reside at a single location or multiple locations.

The memory 144 is a computer-readable, non-transitory storage unit or device, or collection of units/devices, that may include persistent and/or non-persistent memory components. The memory 144 stores the instructions of a text generator 150, an image selector 152, a template module 154, and a video synthesizer 156, each of which may be executed by the processor 142. The text generator 150 includes a prompt generator 160 and a generative artificial intelligence (AI) model 162. The image selector 152 includes a relevance module 164 and a machine learning (ML) model 166. In some implementations, some of the software modules/units shown in FIG. 1 are omitted. For example, the image selector 152 may omit the relevance module 164 and/or ML model 166, or the image selector 152 may be omitted in its entirety.

The modules 150, 152, 154, and 156 are software modules comprising instructions executed by the processor 142 to generate (or “synthesize”), or facilitate the generation of, video content. The video content may be generated for any purpose. For example, the computing system 104 may generate the video content to serve as an advertisement or promotion for content sponsor 108, which may then be included in a web page or other information resource of publisher 106 (or in a mobile application screen, etc.), or another publisher, when selected via an auction or other ad selection process. As another example, system 100 may omit content sponsor 108, and the computing system 104 may generate the video content on a periodic basis for automatic/unconditional inclusion in a web page hosted by the publisher 106 (e.g., to provide new and continually changing experiences for website visitors, and thereby help to attract repeat visitors). For case of explanation, however, the examples provided herein refer primarily to implementations/scenarios in which the video content is an advertisement associated with the content sponsor 108.

Generally, the text generator 150 generates text content that will in turn be used as an input for generating the video content, the image selector 152 selects image content that will also be used as an input for generating the video content, and the template module 154 selects a template for use in generating the video content. The template is, or is associated with (e.g., is an identifier linked to), a template model that operates on text content and image content (i.e., the template model inputs) and defines one or more temporal characteristics, such that video content generated using the template model conforms to the defined temporal characteristic(s).

The temporal characteristic(s) defined by the template model may include, for example, a sequence of video segments, and/or an animation within a video segment. The video content as a whole may include one or more video segments, with each video segment having a particular visual theme (e.g., an introductory segment with frenetic movement to grab a viewer's attention), a particular messaging theme (e.g., a segment that focuses on technical details of a product, a segment that focuses on visual appearance of the product, a segment that focuses on positive reviews of the product, etc.), and so on. An animation may be, for example, a particular movement of text or objects within a particular video segment (e.g., with defined positions/paths of movement, speeds of movement, etc.). The template model may also define other temporal characteristics, such as visual effects (e.g., flashing, fade in/out, etc.), the length of the video (e.g., 30 seconds, 1 minute, etc.), and so on. In some implementations, the length of the video is an additional input to the template model (in addition to the text content and the image content). In some implementations, the template model defines non-temporal characteristics as well, such as colors (e.g., for particular objects and/or backgrounds), sizes (e.g., for fonts and particular objects, etc.), and so on.

The video synthesizer 156 generates the video content by applying the text content generated by text generator 150 (and possibly also other text content), and the image content selected by image selector 152 (and possibly also other image content), as inputs to the template model selected by the template module 154. The operation of the text generator 150, the image selector 152, the template module 154, and the video synthesizer 156, and their constituent parts, will be discussed in further detail below in connection with various example implementations.

In the example implementation of FIG. 1, the content sponsor 108 is communicatively coupled with a static content database 170, and the computing system 104 is communicatively coupled with a template database 172, a video content database 174, and a user information database 180. Each of the databases 170, 172, 174, and/or 180 may be stored in a local memory (e.g., template database 172 may be stored in the memory 144), or may be stored in memory remote from the coupled device/system (e.g., the template database 172 may be stored in a memory remote from the computing system 104).

The static content database 170 includes image content, which may be image advertisements created by the content sponsor 108, for example. In some implementations, the content sponsor 108 selects desired image content and transmits that image content to the computing system 104 for use by video synthesizer 156, such that the image selector 152 may be omitted. In other implementations, the content sponsor 108 transmits image content to the computing system 104, but the image selector 152 selects particular images from among that content for use by the video synthesizer 156. In other implementations, the content sponsor 108 provides remote access to the computing system 104, and the image selector 152 selects images from the static content database 170. In some implementations, the static content database 170 also includes text content (e.g., text advertisements created by the content sponsor 108). In still other implementations, the static content database 170 is stored/maintained by the computing system 104 rather than the content sponsor 108. In some of these latter implementations, the computing system 104 or another computing system generates the images stored in static content database 170 using a multimodal generative AI model that operates on text (e.g., an Imagen model), or operates on text and other images (e.g., a Pathways Language and Image, or PaLI, model).

The template database 172 includes a number of template models from which the template module 154 can select a particular template model. The video content database 174 may store the video content generated by the video synthesizer 156. In other implementations, however, the computing system 104 transmits the generated video content to the content sponsor 108, without any longer term storage of the video content.

The user information database 180 stores information associated with the user of client device 102, and the users of other similar devices, that the users previously agreed to share for use by the entity associated with the computing system 104. For example, the user information database 180 may store user location information, indications of video content previously watched by users (e.g., URLs, categories, titles, etc.), user profiles (e.g., demographic information such as age, gender, etc.), and/or user preference information.

In some implementations, publishers (including publisher 106) and/or content sponsors (including content sponsor 108) hold accounts related to the services provided by the computing system 104. For example, the publishers may create such accounts in order to monetize information resources that they publish or otherwise make available (e.g., by selling advertising in content slots on the publishers' hosted web pages), and/or the content sponsors may create such accounts in order to locate and purchase content slots in which it would be particularly advantageous to present their content (e.g., advertisements). In these implementations, information associated with the publisher and/or content sponsor accounts may be stored in an account database (not shown in FIG. 1). The account database may be stored in the memory 144, or may be stored in one or more memories that are remote from the computing system 104, for example. The account information may include information such as entity name, subscription level, entity preferences (e.g., brand control preferences), and so on. In some implementations, the account information includes selection parameters (e.g., bid amounts or maximum bid amounts) associated with different content sponsors, for use by the computing system 104 or a different computing system in selecting content for inclusion in content slots of publishers' information resources.

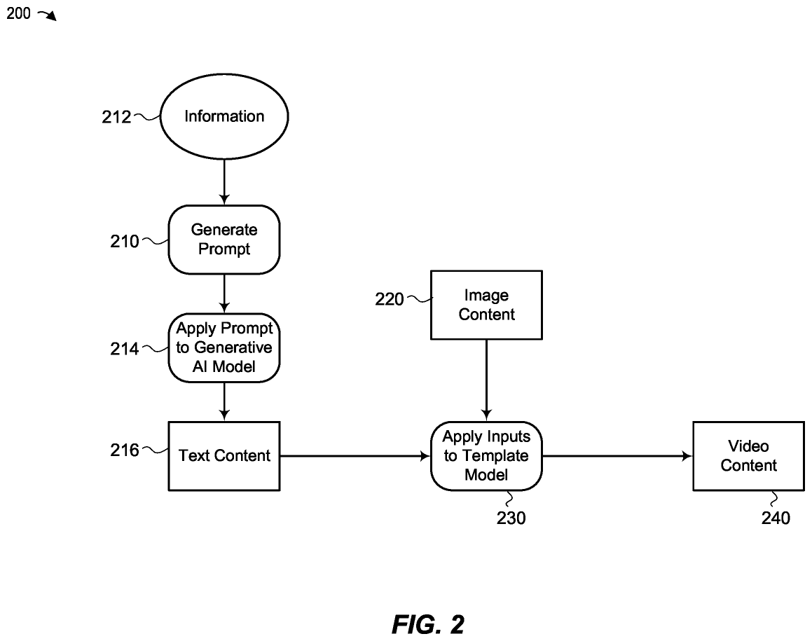

FIG. 2 depicts an example process 200 for efficiently generating high-quality video content that may be used, for example, as a video advertisement for the content sponsor 108 (e.g., for placement in a web page hosted by the publisher 106 or in a mobile application page). The process 200 may be performed by the computing system 104 of FIG. 1 (e.g., by the processor 142 when executing instructions stored in memory 144), for example.

At stage 210 of the process 200, the prompt generator 160 generates a text prompt based on information 212. In some implementations, the prompt generator 160 generates the prompt using a prompt template, which may be a text string with one or more fields for plugging in input text. The fields may include one or more fields that the prompt generator 160 populates based on user input (e.g., provided by the content sponsor 108), one or more fields that the prompt generator 160 populates based on default values (e.g., if no user input is provided), and/or one or more fields that the prompt generator 160 populates based on the information 212.

At stage 214, the text generator 150 applies the text prompt as an input to the generative AI model 162, causing the generative AI model 162 to process the text prompt and output text content 216 responsive to the text prompt. The generative AI model 162 may be a deep neural network and, more specifically, may be a large language model (LLM) such as Google's Bard®, for example. Generally, the LLM may perform various natural language processing (NLP) tasks (e.g., classifying text, answering questions, summarizing text, generating text), as needed to understand a text query/prompt and generate a response to the text query/prompt. The LLM may have a transformer model architecture with an encoder and decoder, and may tokenize inputs/text. The transformer model may incorporate self-attention mechanisms to facilitate faster learning/training and/or more accurate output. In some implementations, the LLM includes many layers of neural networks, possibly including a number of embedding layers, a number of feedforward layers, and a number of recurrent layers. In some implementations, the LLM is a multimodal LLM that can also accept inputs in modalities other than text, such as image, video, and/or audio features. In these implementations, the text generator 150 may map the embeddings from other modalities (images, video, and/or audio) to the same space to which the text generator 150 maps text token embeddings. In some implementations, the LLM is trained to perform sentiment analysis. In some implementations, the generative AI model 162 is not an LLM. For example, the generative AI model 162 may instead include a less complex neural network.

The generative AI model 162 may have been trained by computing system 104 or another computing system using supervised or semi-supervised learning, and with training data of the appropriate modality (text) or modalities (text as well as images, videos, and/or audio). The generative AI model 162 may be a general-purpose model (e.g., trained on a wide array of publicly available datasets such as web pages, documents, etc., available via the Internet) or may be a domain-specific model (e.g., trained on custom and/or proprietary datasets, such as documents/data available via one or more intranets). In some implementations, the generative AI model 162 is an LLM with parameters tuned, via the training process, specifically for high performance in the context of generating text having one or more particular qualities and/or characteristics. In the digital advertising context, for example, the LLM may be trained/tuned to generate text that users generally find to be appealing, or that generally grab users' attention. Training of this sort may include the use of human-generated input to train and/or refine the LLM, such as human reviews of the quality of advertising text generated by the LLM.

In some implementations, stage 214 includes accessing a remote server/system that provides generative AI as a service (i.e., with at least a portion of text generator 150 residing at a location remote from the computing system 104). In other implementations, stage 214 includes using a text generator 150 that is local to the computing system 104. Thus, the trained generative AI model 162 may reside at the computing system 104 as shown in FIG. 1, or the computing system 104 may access the generative AI model 162 by communicating with another computing system via the network 110. For example, the generative AI model 162 may be an LLM that a remote server makes available to computing systems (including computing system 104) via an application programming interface (API).

In some implementations, the computing system 104, or another computing system, derives the generative AI model 162 from another, larger generative AI model. For example, the computing system 104 may use (e.g., access) a remote, larger LLM to make bulk inferences, and then train the generative AI model 162 (e.g., a smaller LLM) on those bulk inferences. In these implementations, where the generative AI model 162 can be considered a “student” model, complexity and/or processing/memory resource consumption can be greatly reduced compared to use of the much larger LLM. This can be particularly important, for example, in online ad serving or other “on-the-fly” use cases.

The information 212 may generally include any information associated with the content sponsor 108 (e.g., information potentially relevant to a product or service being advertised by the content sponsor 108) and/or information associated with the user of the client device 102 (e.g., information potentially relevant to the interests of the user).

Information 212 associated with the content sponsor 108 may include, for example, information in a web page associated with the content sponsor 108, such as a web page that the content sponsor 108 will use as a landing page for an advertisement that includes the video content being generated by the process 200 (i.e., a landing page to be presented in response to user selection of the advertisement/video content). As another example, the information 212 may include audience information provided by the content sponsor 108 (e.g., audience demographics, audience interests, etc.).

Information 212 associated with the user of the client device 102 may include, for example, a search query (text string) entered by the user of the client device 102 in a search engine application or a web page hosted by a search engine server. As another example, the information 212 may include a location of the user of the client device 102 (e.g., a global positioning system (GPS) location of the client device 102, if the user has previously agreed to share his or her location for use by an entity associated with the computing system 104). In still other examples, the information 212 may include an indication of other video content previously watched by the user (e.g., a category or name of previously viewed video content), a profile of the user of the client device 102 (e.g., the user's age, gender, etc., if the user agreed to the use of such information), and/or one or more preferences of the user (e.g., categories for which the user has a preference or affinity, if the user agreed to the use of such information).

In some implementations, instead of or in addition to any of the types of text information described above (e.g., search queries, text from web pages, etc.), the information 212 may include information derived from or otherwise associated with the initial text information. For example, the information 212 may include only salient terms from a search query, only the text from a digital advertisement, or metadata (e.g., a description or headline) of a digital advertisement. As another example, the information 212 may include one or more words or phrases that the computing system 104 (or another computing system) had obtained using any of the types of text information discussed above and a knowledge graph (semantic network) that associates words or phrases from the text information with other text, e.g., in order to provide more context to the generative AI model 162.

In addition to any of the information associated with the content sponsor 108 and/or the user of the client device 102 as discussed above, the information 212 may include other information. For example, the information 212 may include the current time, day, or season.

As a more specific example of stages 210 and 214, a prompt template may be “Generate [#_LINES] advertisement lines for [ADV_WEBSITE], under [MAX_WORD_COUNT] words, that are of interest to any user searching for [USER_QUERY] in [LOCATION]”, where “#_LINES” and “MAX_WORD_COUNT” are positive integers provided by the content sponsor 108 or the publisher 106 to indicate desired number of lines (e.g., phrases or sentences) and the desired maximum number of words, respectively, “ADV_WEBSITE” is a uniform resource locator (URL) of a web page associated with the content sponsor 108 (e.g., a landing page for a video advertisement being generated by the process 200), “USER_QUERY” is a search query just recently entered by a user of the client device 102, and “LOCATION” is a known current location of the user of the client device 102. The text generator 150 may obtain the input for the various fields from the content sponsor 108 and the client device 102, populate the fields accordingly, and then apply the populated prompt to the generative AI model 162. In response, the generative AI model 162 outputs text content 216 having the desired number of sentences/phrases and no more than the desired maximum number of words.

As another example, the prompt template may be “Provide the best advertising phrase that is for an advertiser associated with images A, B, and C, audio tracks D, E, and F, and landing page P, is of interest to any user entering a search query Q, and satisfies constraints X, Y, and Z.” In this example, A, B, and C may be images provided by the content sponsor 108, D, E, and F may be audio tracks provided by the content sponsor 108, P may be the URL of a landing page of the content sponsor 108, Q may be a search query entered by the user (e.g., if a video advertisement is being generated “on-the-fly” responsive to that search query), and X, Y, and Z may be constraints such as maximum word count, number of phrases/sentences, and so on.

At stage 230 of the process 200, the video synthesizer 156 applies the text content 216 and image content 220 as inputs to a template model. In some implementations, the image content 220 includes one or more images from static content database 170, which the content sponsor 108 may send to the computing system 104 via the network 110. As discussed above, the image content 220 can be retrieved and/or generated in various different ways, in different implementations. The images may be image advertisements of the content sponsor 108, for example, and may be manually created or created using a generative AI model, etc. In some implementations, stage 230 includes accessing a remote server/system that provides video synthesis as a service (i.e., at least a portion of the video synthesizer 156 resides at a location remote from the computing system 104). In other implementations, stage 230 includes using a video synthesizer 156 that is local to the computing system 104.

In other implementations, the image selector 152 selects one or more images from a larger pool of candidate images (e.g., a collection of candidate images stored in static content database 170 and sent from content sponsor 108 to the computing system 104). To facilitate this selection, the relevance module 164 may use the ML model 166 to determine a relevance score for each of multiple candidate images. The “relevance” score for a given image may be a direct measure of relevance (e.g., similarity) to a user or user context, for example, or may be a performance metric that indicates the likelihood that a user takes an interest in the image, etc. For instance, the relevance score for a given image may be an estimated probability that the user of the client device 102 would “click” on an advertisement including that image (or click on a video advertisement that incorporates that image, etc.). The image selector 152 selects the image(s) based on the determined relevance scores (e.g., by choosing the X highest-scoring images, where X is a predetermined number greater than zero, or by choosing all images with a relevance score greater than some predetermined threshold, etc.).

In addition to applying each candidate image as an input the ML model 166, the relevance module 164 may apply one or more signals indicating the factor(s) on the basis of which relevance is being determined. For example, if the relevance module 164 is scoring the relevance of images to a user's search query, the relevance module 164 may apply text from the search query of the user of the client device 102 as another input to the ML model 166. Generally, inputs to the ML model 166 may include any of the information discussed above with reference to information 212, for example.

The ML model 166 may include a neural network suitable for analyzing images, such as a convolutional neural network. In some implementations, the ML model 166 includes multiple neural networks (e.g., one for processing images and another for processing user search queries, with the output of each neural network being fed into a third neural network or an algorithm that determines the relevance score). The neural network(s) may have been trained by the computing system 104 or another computing system (e.g., using supervised learning techniques).

The template model to which the video synthesizer 156 applies the inputs at stage 230 may be selected by the template module 154 using fixed rules or algorithms, based on a selection from the content sponsor 108 or publisher 106, or using a machine learning model such as a neural network, for example. The neural network or other machine learning model may predict a performance metric (e.g., estimated probability of a “click” by the user on a video generated using the template) for each of multiple candidate templates, based on one or more signals (e.g., landing page information and/or user search query text, or any of the information 212, as discussed above). The inputs to the neural network also include one or more signals associated with the template under consideration (e.g., a category or type of the template, and/or a number of descriptive characteristics of the template, etc.). The template module 154 then selects the template with the highest predicted performance metric (e.g., highest estimated probability of a click).

The video synthesizer 156 then applies the text content 216 and image content 220 as inputs to the selected template (e.g., a template model corresponding to a selected template identifier), to create the video content 240 in accordance with the temporal (and possibly other) characteristics defined by the selected template.

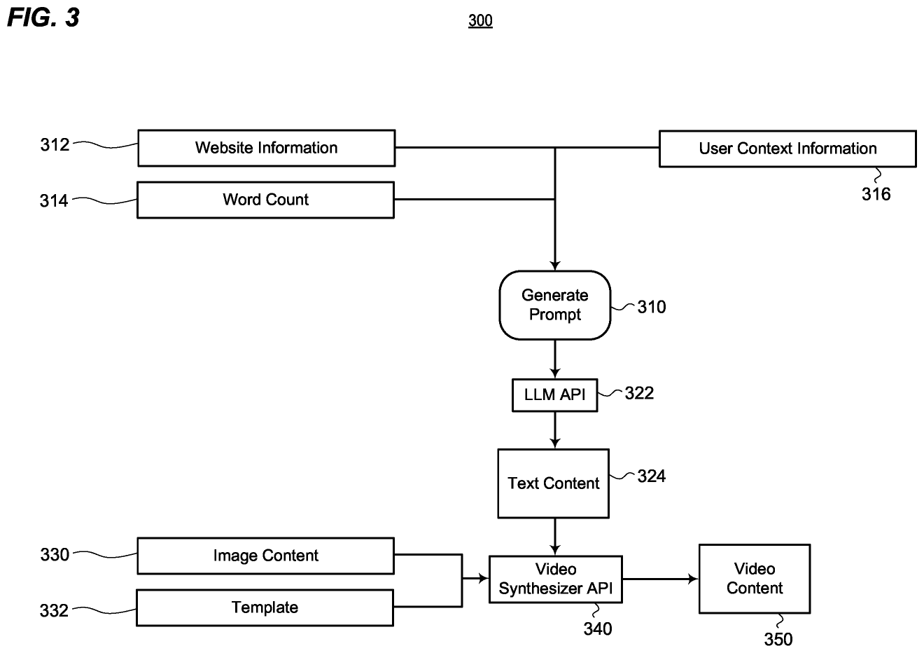

FIG. 3 depicts a process 300, which is a more specific example of the process 200 of FIG. 2, according to one implementation. Like the process 200, the process 300 may be performed by the computing system 104 of FIG. 1 (e.g., by the processor 142 when executing instructions stored in memory 144), for example.

At stage 310 of the process 300, the prompt generator 160 generates a text prompt. Stage 310 may be similar to stage 210 of FIG. 2, for example. In the implementation shown, the prompt generator 160 generates the prompt based on website information 312 associated with the content sponsor (e.g., text and/or other information from a landing page of an advertiser or other content sponsor), a desired maximum (or minimum, or exact, etc.) word count 314, and user context information 316. The word count 314 may be provided by the content sponsor or by a user of the computing system 104, or may be a fixed or default value, for example. In some implementations, the prompt generator 160 instead, or also, generates the prompt based on information other than website information 312 (e.g., based on any suitable type of information associated with an advertiser or other content sponsor). The user context information 316 may include, for example, a search query entered by user at a client device (e.g., client device 102), a location of the user (e.g., based on a GPS or other location signal from client device 102, if the user agreed to the use/storage of his/her location), an indication of other video content previously watched by the user (e.g., as stored in user information database 180, if the user agreed to the use/storage of such information), a profile of the user (e.g., as stored in user information database 180, if the user agreed to the use/storage such information), and/or a preference of the user (e.g., as stored in user information database 180, if the user agreed to the use/storage of such information). The prompt generator 160 may use the information 312, 316 and word count 314 to populate fields of a prompt template as discussed above.

In the implementation of FIG. 3, the generative AI model 162 is an LLM of a service hosted by a remote server and accessible via an LLM API 322. Thus, the text generator 150 uses the LLM API 322 (i.e., the definitions, protocols, etc., of the LLM API 322) to provide the generated text prompt as an input to the LLM. The LLM then processes the text prompt and returns (e.g., also via the LLM API 322) text content 324 that is responsive to the text prompt, in accordance with the word count 314 and any other inputs/constraints (e.g., a desired number of sentences or phrases). In some implementations where the generative AI model 162 is a multimodal LLM (as discussed above), the LLM generates the text content 324 by processing not only text (e.g., a text prompt), but also image(s), video, and/or audio content (e.g., as provided by content sponsor 108 and/or stored locally at computing system 104).

In the implementation of FIG. 3, the template-guided video synthesis is a service hosted by a remote server and accessible via a video synthesizer API 340. Thus, the video synthesizer 156 uses the video synthesizer API 340 (i.e., the definitions, protocols, etc., of the video synthesizer API 340) to provide the text content 324, along with image content 330, as inputs to the template model. FIG. 3 depicts an implementation in which the content sponsor provides the desired image content 330, and indicates the desired template 332, to the computing system 104. In other implementations, however, the computing system 104 selects a particular set of one or more images forming the image content 330 and/or selects the template 332 (e.g., using machine learning techniques for one or both tasks as discussed above).

The video synthesizer 156 then processes the text content 324 and image content 330 using the template 332, and returns (e.g., also via the video synthesizer API 340) video content 350 that is based on the input text/image(s) but conforms to the temporal (and perhaps other) characteristics defined by the template model of template 332.

In some implementations and/or scenarios, the computing system 104 performs the process 200 of FIG. 2 or the process 300 of FIG. 3 “on-the-fly.” shortly before the video content 240 or 350 is to be delivered to the client device 102 for presentation to a user. If the process 200 or 300 is being used to provide digital advertising to the user of client device 102 responsive to the user's search query, for example, the computing system 104 may obtain the search query information (e.g., information 212 or user context information 316) in response to the user entering the search query, and proceed to perform the rest of process 200 or 300 at that time. The computing system 104 or another computing system may then provide the video content 240 or 350 to the client device 102 for presentation to the user (e.g., within a content slot of a web page of publisher 106 that is being visited by the user), or may provide the video content 240 or 350 as a candidate in an ad auction or other content selection process run by the computing system 104 or another computing system.

In other implementations and/or scenarios, the computing system 104 performs the process 200 or the process 300 offline. For example, the process 200 or the process 300 may be performed offline for each of N search queries that are expected to be (and/or previously were) entered by users, where N is any suitable integer greater than zero (e.g., 10, 100, 10,000, etc.). The process 200 or the process 300 can substantially reduce the usage of processing resources (e.g., memory and/or processing cycles), which can be particularly important for large N and/or for a large number of query sets.

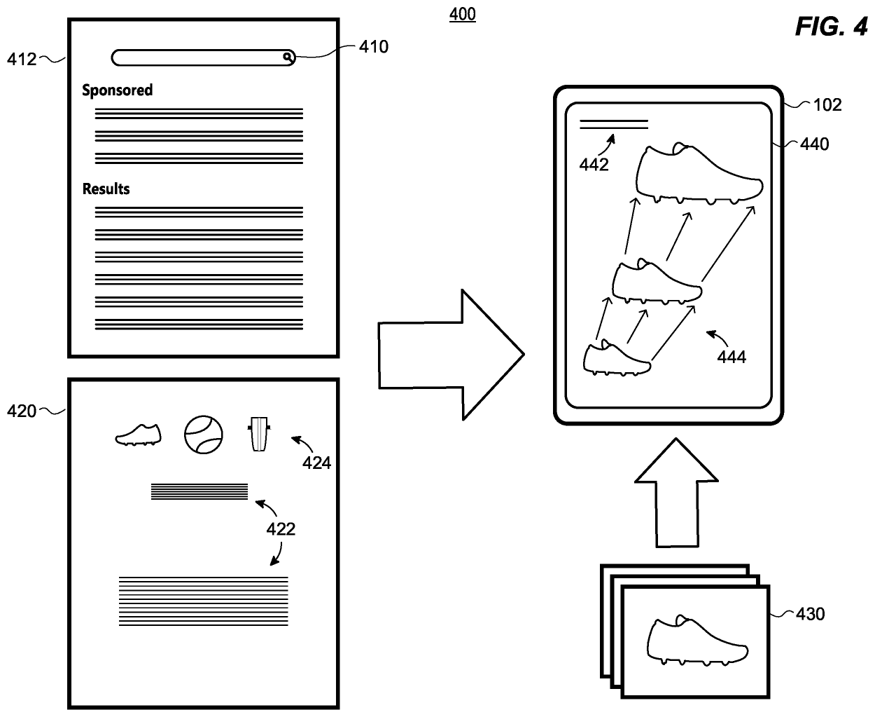

FIG. 4 depicts an example video synthesis scenario 400, according to one implementation of the techniques disclosed herein. In the scenario 400, the information 212 of FIG. 2 or the user context information 316 of FIG. 3 includes a search query entered by a user of client device 102 in a query prompt/field 410 of a search page 412 (e.g., web page or mobile application page). Moreover, the information 212 or the website information 312 includes information from a landing page 420 of the content sponsor 108. The information from the landing page 420 includes text 422 and, in some implementations, images 424. Also in the scenario 400, the image content 220 or the image content 330 includes a set of one or more images 430. In some implementations, the image content 330 includes one or more of images 424. In other implementations, the image content 330 is not related to any of the images 424, and/or the landing page 420 does not include images 424. As discussed above, for example, the image content 330 may be one or more images from static content database 170, as maintained by the content sponsor 108 or the computing system 104.

The video content 240 or video content 350 is represented in FIG. 4 as video content 440. The video content 440, in this example, includes text 442 and an animation 444, with the arrows indicating a path of movement over time. The animation 444 and the positioning/size/etc. of the text 442 may both be dictated by the temporal model being applied by the video synthesizer 156. Moreover, the text 442 and animation 444 shown in FIG. 4 may correspond to only one of multiple segments defined by the temporal model.

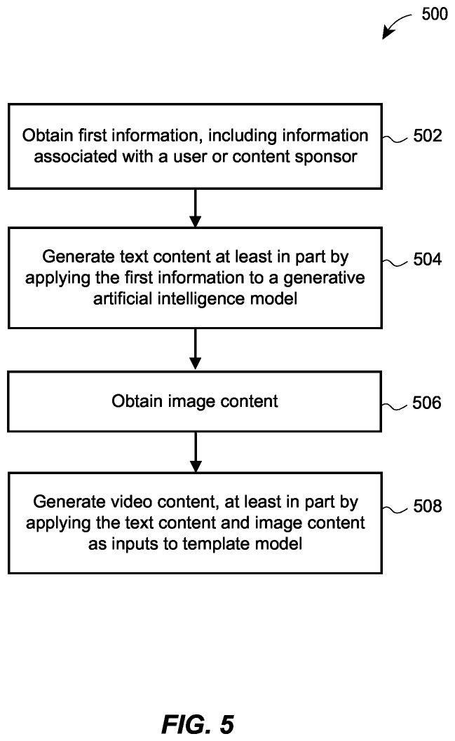

FIG. 5 is a flow diagram of an example method 500 for efficiently generating high-quality video content. The method 500 may be implemented as instructions stored on one or more computer-readable media and executed by one or more processors in one or more computing devices. For example, the method 500 may be implemented by the processor 142 of the computing system 104 in FIG. 1, when executing instructions of the text generator 150, image selector 152, template module 154, and/or video synthesizer 156.

At block 502 of the method 500, first information, including information associated with a user (e.g., a user of client device 102) or a content sponsor (e.g., content sponsor 108), is obtained. In some implementations, the first information includes information associated with both a user and a content sponsor. The information associated with user and/or the information associated with the content sponsor may be any of the respective types of information discussed above in connection with FIGS. 1-4 (e.g., a user search query, landing page information, etc.). The first information may also include other information, such as the current time of day, the current day (date or day of the week), and/or the current season (e.g., winter, spring, etc.).

At block 504, text content is generated at least in part by applying the first information to a generative artificial intelligence model. The generative artificial intelligence model (e.g., generative AI model 162) may be a deep neural network (e.g., an LLM). Block 504 may include running the generative artificial intelligence model directly, or accessing (e.g., via an API or website) a remote server that maintains/runs the model, for example. In some implementations, block 504 includes generating a prompt based on the first information and a prompt template (and possibly a desired maximum word count, and desired number of sentences or phrases, etc.), and applying the prompt as input to the generative artificial intelligence model.

At block 506, image content is obtained. Block 506 may include obtaining the image content from a content sponsor, or selecting the image content, for example. Selecting the image content may include selecting the image content from a larger pool of image content provided by the content sponsor, and/or may include using a machine learning model to select the image content as discussed above.

At block 508, video content is generated. Block 508 includes applying the text content generated at block 508 and the image content obtained at block 506 as inputs to a template model. Block 508 may include directly applying the template model, or accessing (e.g., via an API or website) a remote server that uses the template model to generate video, for example. The template model causes the generated video content to conform to one or more temporal characteristics defined by the template model (e.g., as discussed above). In some implementations, block 508 further includes selecting the template model (e.g., based on performance metrics predicted using a machine learning model, as discussed above).

In some implementations, the method 500 also includes a block in which the generated video content is provided to a client device (e.g., client device 102) for presentation to the user (e.g., within a content slot of a web page hosted by the publisher 106, or within a content slot of a user interface/screen/page provided by a mobile application). In other implementations, the method 500 also includes providing the generated video content to another computing system for use as a candidate advertisement in an auction, or locally running an auction using the video content as a candidate advertisement, etc. In other implementations, the method 500 also includes sending the video content to the content sponsor 108 for storage, and/or locally storing the video content in video content database 174.

In some implementations, and as noted above, the techniques disclosed herein use artificial intelligence to facilitate the efficient generation of high-quality video content. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

In some implementations, the computing system 104 may use any one or more the machine learning models noted above to perform any one or more of the operations discussed herein in connection with machine learning. For example, the computing system 104 may use one or more such machine learning models to generate text, to determine relevancy scores of image content, and/or to select a template, as discussed above.

Although the foregoing text sets forth a detailed description of numerous different aspects and implementations of the invention, it should be understood that the scope of the patent is defined by the words of the claims set forth at the end of this patent. The detailed description is to be construed as exemplary only.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless specifically stated otherwise, discussions in the present disclosure using words such as “processing.” “computing.” “calculating.” “determining.” “presenting.” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising.” “includes,” “including.” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for efficiently generating high-quality video content through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

What is claimed is:

1. A method for generating video content, the method comprising:
obtaining, by a computing system, first information, the first information including information associated with a user or a content sponsor;
generating, by the computing system, text content at least in part by applying the first information to a generative artificial intelligence model;
obtaining, by the computing system, image content; and
generating, by the computing system, video content, at least in part by applying the text content and the image content as inputs to a template model, wherein the template model causes the generated video content to conform to one or more temporal characteristics defined by the template model.

2. The method of claim 1, wherein the generative artificial intelligence model includes a deep neural network.

3. The method of claim 2, wherein the deep neural network is a large language model.

4. The method of claim 1, wherein generating the text content includes:
generating a prompt based on the first information and a prompt template; and
applying the prompt as input to the generative artificial intelligence model.

5. The method of claim 4, wherein generating the prompt is further based on a desired maximum word count.

6. The method of claim 4, wherein generating the prompt is further based on a desired number of sentences or phrases.

7. The method of claim 1, wherein the first information includes information associated with the content sponsor.

8. The method of claim 7, wherein the information associated with the content sponsor includes information in a web page associated with the content sponsor.

9. The method of claim 8, wherein the web page is a landing page to be presented in response to user selection of the video content.

10. The method of claim 1, wherein the first information includes information associated with the user.

11. The method of claim 10, wherein the information associated with the user includes a search query entered by the user.

12. The method of claim 10, wherein the information associated with the user includes one or more of:
a location of the user;
an indication of other video content previously watched by the user;
a profile of the user; or
a preference of the user.

13. The method of claim 1, wherein the first information includes a current time, day, or season.

14. The method of claim 1, further comprising:
predicting, using a machine learning model, a performance metric for each of a plurality of candidate templates, the template model corresponding to a first template of the plurality of candidate templates; and
selecting the first template based on the predicted performance metrics.

15. The method of claim 14, wherein the performance metric is a user click probability.

16. The method of claim 1, wherein obtaining the image content includes:
determining, using a machine learning model, a relevance score for each of a plurality of candidate images, the image content consisting of one or more images of the plurality of candidate images; and
selecting the one or more images based on the determined relevance scores.

17. The method of claim 1, wherein the one or more temporal characteristics include one or both of (i) a sequence of video segments, and (ii) an animation within a video segment.

18. A computing system comprising:
one or more processors; and
one or more non-transitory, tangible memories storing instructions that, when executed by the one or more processors, cause the computing system to:
obtain first information, the first information including information associated with a user or a content sponsor;
generate text content at least in part by applying the first information to a generative artificial intelligence model;
obtain image content; and
generate video content, at least in part by applying the text content and the image content as inputs to a template model, wherein the template model causes the generated video content to conform to one or more temporal characteristics defined by the template model.

19. The computing system of claim 18, wherein the generative artificial intelligence model includes a large language model, and wherein generating the text content includes:
generating a prompt based on the first information and a prompt template; and
applying the prompt as input to the large language model.

20. The computing system of claim 19, wherein generating the prompt is further based on one or both of (i) a desired maximum word count and (ii) a desired number of sentences or phrases.

21. The computing system of claim 18, wherein the first information includes information in a web page associated with the content sponsor.

22. The computing system of claim 18, wherein the first information includes one or more of:
a search query entered by the user;
a location of the user;
an indication of other video content previously watched by the user;
a profile of the user; or
a preference of the user.

23. The computing system of claim 18, wherein the instructions further cause the computing system to:
predict, using a machine learning model, a performance metric for each of a plurality of candidate templates, the template model corresponding to a first template of the plurality of candidate templates; and
select the first template based on the predicted performance metrics.

24. The computing system of claim 18, wherein obtaining the image content includes:
determining, using a machine learning model, a relevance score for each of a plurality of candidate images, the image content consisting of one or more images of the plurality of candidate images; and
selecting the one or more images based on the determined relevance scores.
